(19) United States
(12) Patent Application Publication
(10) Pub. No.: US 2025/0005503 A1
(43) Pub. Date: Jan. 2, 2025

(54) USE OF GEOSPATIAL COORDINATE SYSTEMS FOR TRACKING ITEM DELIVERY

(71) Applicant: United States Postal Service, Washington, DC (US)

(72) Inventors: Anoosha Koohi, McLean, VA (US); Charles P. McLellan, Fairfax, VA (US)

(21) Appl. No.: 18/886,140

(22) Filed: Sep. 16, 2024

Related U.S. Application Data
(63) Continuation of application No. 16/386,661, filed on Apr. 17, 2019.
(60) Provisional application No. 62/660,788, filed on Apr. 20, 2018.

(51) Int. Cl. G06Q 10/0833; G06F 16/29; G06Q 10/083; H04W 4/021

(52) U.S. Cl. CPC G06Q 10/0833; G06F 16/29; G06Q 10/0838; H04W 4/021

(57) ABSTRACT

A system and method for determining delivery points associated with particular addresses. In some embodiments, mobile devices can record the geo-location that an item carrier is at when making a delivery of an item. An address association server can receive these locations, organize the recorded geo-locations into clusters, and then calculate accurate delivery points based upon those clusters for a specific address.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This Application is a Continuation of U.S. patent application Ser. No. 16/386,661, filed Apr. 17, 2019, which claims the benefit of priority to U.S. Provisional Patent Application No. 62/660,788 filed Apr. 20, 2018, the entire contents of which are incorporated by reference.

### BACKGROUND

The development relates to a system and method for updating delivery coordinates for various delivery points based upon the coordinates of the actual deliveries that occur there.

Item carriers generally wish to be able to perform many functions that rely on accurate knowledge of where deliveries need to occur. For example, item carriers may need to have accurate knowledge of delivery points in order to determine expected delivery windows for deliveries, or to send notifications to item deliverers as they approach delivery points. Accordingly, a system for accurately determining the precise geo-coordinates for a delivery point is greatly desired.

### SUMMARY

A system and method for determining delivery points associated with a particular address is described hereto. In some embodiments, mobile devices can record the geographic location of item carrier when the carrier is making a delivery of an item. An address association server can receive these locations, organize the recorded geo-locations into clusters using a cluster identification module, and then calculate accurate delivery points based upon those clusters for a specific address. The address association server can then select one of these delivery points to upload to an address management system using a cluster selector module. Also described hereto is some embodiments of a system for determining the geolocation of a delivery point. In one aspect described herein A system comprises a communication module configured to receive scan data and a cluster identification module configured to identify a cluster of scans in the scan data based on the geolocation of scans in the scan data and determine the geolocation of at least one delivery point based in part on the cluster. In some embodiments, the cluster identification module further uses a DBSCAN methodology to determine the geolocation of a delivery point from the cluster.

Ins some embodiments, the system is further configured to determine the geolocation of multiple delivery points for a single address.

In some embodiments, the system further comprises a cluster confidence module configured to determine a confidence value for the geolocation of the delivery point.

In some embodiments, the confidence value is determined at least in part on one or more of the number of scans in the cluster; the proximity of the geolocation of each scan in the cluster to the geolocation of the other scans in the cluster; the distance from the determined delivery point to any past determined delivery point; the number or identity of carries that performed the scans; or the number of different days from which at least one scan in the cluster was collected.

In some embodiments, the confidence value is determined based on all of the number of scans in the cluster; the proximity of the geolocation of each scan in the cluster to the geolocation of the other scans in the cluster; the distance from the determined delivery point to any past determined delivery point; the number or identity of carries that performed the scans; and the number of different days from which at least one scan in the cluster was collected.

In some embodiments, the system also comprises a delivery point database and a cluster selection module configured to determine whether to update the delivery point database based on the confidence value.

Also disclosed is some embodiments of a method for determine the geolocation of a delivery point. In some embodiments, the method comprises receiving scan data, identifying a cluster of scans in the scan data based on the geolocation of scans in the scan data, and determining the geolocation of at least one delivery point based in part on the cluster.

In some embodiments, the method can further comprise using a DBSCAN methodology to determine the geolocation of a delivery point from the cluster.

In some embodiments, the method can further comprise determining the geolocation of multiple delivery points for a single address.

In some embodiments, the method can further comprise determining a confidence value for the geolocation of the delivery point.

In some embodiments, the confidence value is determined at least in part on one or more of the number of scans in the cluster; the proximity of the geolocation of each scan in the cluster to the geolocation of the other scans in the cluster; the distance from the determined delivery point to any past determined delivery point; the number or identity of carries that performed the scans; or the number of different days from which at least one scan in the cluster was collected.

In some embodiments, the confidence value is determined based on all of the number of scans in the cluster; the proximity of the geolocation of each scan in the cluster to the geolocation of the other scans in the cluster; the distance from the determined delivery point to any past determined delivery point; the number or identity of carries that performed the scans; and the number of different days from which at least one scan in the cluster was collected.

In some embodiments, the method further comprises determining whether to update a delivery point database based on the confidence value.

Also disclosed are some embodiments of a system for determining the geolocation of a delivery point comprising a communication module configured to receive stop data, a stop analysis module configured to identify a cluster of stops in the stop data based on the geolocation of stops in the stop data, and determine the geolocation of at least one delivery point based in part on the cluster.

In some embodiments, the stop analysis module is further configured to identify an anchor point and to identify the cluster of stops based on the proximity of the geolocation of stops in the stop data to the geolocation of the anchor point.

In some embodiments, the stop analysis module further configured to identify a cluster of stops in the stop data based on the bearing of the stops in the stop data.

In some embodiments, the stop analysis module is configured to include a stop in the cluster of stops when the bearing of the stop show that the stop occurred when a carrier was coming from one delivery point on a route and heading to a another delivery point on the route.

In some embodiments, the stop analysis module further configured to identify a cluster of stops in the stop data based on the time window that the stop occurred within.

In some embodiments, the stop analysis module is configured to identify the anchor point from one of an AAS1 point, a point received from a parcel database, and a point received form an address management server.

Also disclosed are some embodiments of a method for determining the geolocation of a delivery point comprising receiving stop data, identifying a cluster of stops in the stop data based on the geolocation of stops in the stop data, and determining the geolocation of at least one delivery point based in part on the cluster.

In some embodiments, the method further comprising identifying an anchor point and to identify the cluster of stops based on the proximity of the geolocation of stops in the stop data to the geolocation of the anchor point.

In some embodiments, the method further comprising identifying a cluster of stops in the stop data based on the bearing of the stops in the stop data.

In some embodiments, the method further comprising including a stop in the cluster of stops when the bearing of the stop show that the stop occurred when a carrier was coming from one delivery point on a route and heading to a another delivery point on the route.

In some embodiments, the method further comprising identifying a cluster of stops in the stop data based on the time window that the stop occurred within.

In some embodiments, the method further comprising identifying the anchor point from one of an AAS1 point, a point received from a parcel database, and a point received form an address management server.

### BRIEF DESCRIPTION OF THE DRAWINGS

The foregoing and other features of the disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with the additional specificity and detail through use of the accompanying drawings.

FIG. 1a is a block diagram displaying one embodiment of an address analytical server.

FIG. 1b is a block diagram that displays one embodiment of how the address analytical server can communicate with external components.

FIGS. 2a-2c are diagrams illustrating the process that the address analytical server can go through to generate new geo-coordinates for a delivery point.

FIG. 3 is a flow chart depicting one embodiment of a process for using the address analytical server to generate new geo-coordinates for a delivery point.

FIG. 4 is flow chart depicting one embodiment of a process for using the address analytical server 100 to generate new geo-coordinates for a delivery point.

### DETAILED DESCRIPTION

It is beneficial to a distribution network to know the precise geo-coordinates of a location they are delivering to. However, current global positioning satellite systems and maps of delivery points may be incorrect or imprecise. For example, a current maps or location database may identify the center point of a house as a delivery point, while the correct delivery point is instead the location of the mailbox or driveway of the house. Therefore, a system for updating the delivery points is greatly desired.

In one aspect of the present disclosure, maps or databases of delivery point coordinates can be used or prepared by tracking the actual locations at delivery of items occurs. In some embodiments, this can be accomplished by using mobile devices to record the GPS coordinates of the location for each delivery at a delivery point that the delivery entity delivers to. Once the numerous GPS coordinates for multiple deliveries at one or more delivery points are recorded, this data for various deliveries can then be grouped into clusters of recorded deliveries. For example, a single cluster could be all of the recorded deliveries for a single delivery point occurring within a specified distance or radius of each other. Once the various clusters have been identified, the system could then calculate a confidence value for each cluster. If a clusters value is high enough, the system could then update the map with a new delivery point for a particular address calculated from the cluster. This and other processes and aspects will be described herein.

The features, aspects, and advantages of the present development will now be described with reference to the drawings of several embodiments which are intended to be within the scope of the embodiments herein disclosed. These and other embodiments will become readily apparent to those skilled in the art from the following detailed description of the embodiments having reference to the attached figures, the development not being limited to any particular embodiment(s) herein disclosed.

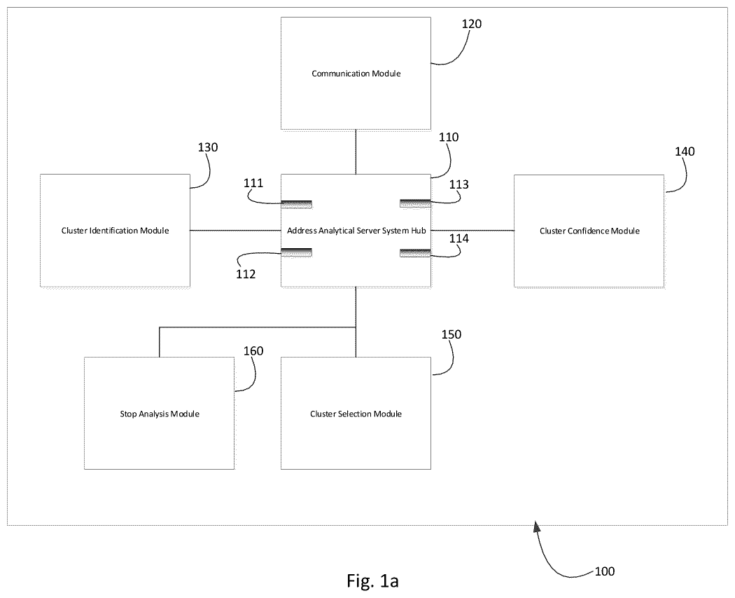

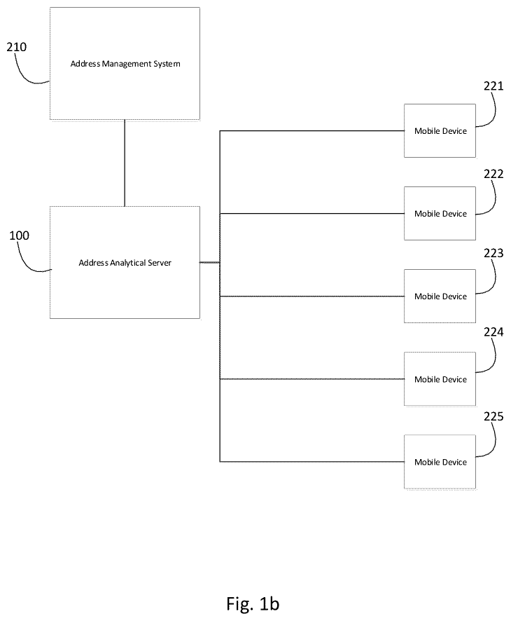

The systems and methods described herein relate to updating a map or database of delivery points. FIG. 1A is a block diagram of an embodiment of an address analytical server 100 (“AAS”) that can be used to update maps of delivery points. In some embodiments, the AAS 100 can comprise an address analytical server system hub 110, a communication module 120, a cluster identification module 130, a cluster confidence module 140, and cluster selection module 150. The address analytical server system hub 110 is in communication, either wired or wirelessly, with a communication module 120, a cluster identification module 130, a cluster confidence module 140, and cluster selection module 150.

In some embodiments, the address analytical server system hub 110 may comprise or be a component of a processing system implemented with one or more processors. The address analytical server system hub 110 may be a network of interconnected processors housed on one or more terminals. The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that may perform calculations or other manipulations of information. The address analytical server system hub 110 may comprise a processor 111 such as, for example, a microprocessor, such as a Pentium® processor, a Pentium® Pro processor, a 8051 processor, a MIPS® processor, a Power PC® processor, an Alpha® processor, a microcontroller, an Intel CORE i7®, i5®, or i3® processor, an AMD Phenom®, A-series®, or FX® processor, or the like. The processor 111 typically has conventional address lines, conventional data lines, and one or more conventional control lines. The processor 111 may be in communication with a processor memory 112, which may include, for example, RAM memory, flash memory, ROM memory, EPROM memory, EEPROM memory, registers, hard disk, a removable disk, a CD-ROM, or any other form of storage medium known in the art. The processor memory 112 may include, for example, software, at least one software module, instructions, steps of an algorithm, or any other information. In some embodiments, the processor 111 performs processes in accordance with instructions stored in the processor memory 112. These processes may include, for example, controlling features and/or components of the expected delivery window generation system 100, and controlling access to and from, and transmitting information and data to and from the address analytical server system hub 110 and the constituent components of the expected delivery window generation system 100, as will be described herein.

The address analytical server system hub 110 comprises a system memory 113, configured to store information, such as confidence data, item-carrier information, expected deliveries data and the like. The system memory 113 may comprise a database, a comma delimited file, a text file, or the like. The address analytical server system hub 110 is configured to coordinate and direct the activities of the components of the expected delivery window generation system 100, and to coordinate generating expected delivery windows for the delivery of items.

In some embodiments, the processor 111 is connected to a communication feature 114. The communication feature 114 is configured for wired and/or wireless communication. In some embodiments, the communication feature 114 communicates via telephone, cable, fiber-optic, or any other wired communication network. In some embodiments, the communication feature 114 may communicate via cellular networks, WLAN networks, or any other wireless network. The communication feature 114 is configured to receive instructions and to transmit and receive information among components of the expected delivery window generation system 100, and in some embodiments, with a central server (not shown) or other resource outside the expected delivery window generation system 100, as desired.

In some embodiments, address analytical server system hub 110 is in communication with communication module 120. In some embodiments, the communication module 120 may comprise a processor, memory, databases, address and control lines, and other components similar to those described herein for the system hub 110. In other embodiments, communication module 120 may be configured to use the processor, memory, databases, address and control lines, and other components of the address analytical server system hub 110, or a combination of its own components and the address analytical server system hub 110's components.

Communication module 120 can be used by address analytical server 100 to communicate with other servers or mobile devices outside the address analytical server. For example, communication module 120 can be used by AAS 100 to communicate with address mapping server 210 and mobile devices 221-225, as shown in FIG. 1b. It is to be understood that there is not a particular number of mobile devices that are required and that the AAS 100 can communicate with any number of mobile devices. In some embodiments, the communication module 130 is configured to receive information from the mobile devices 221-225 about the deliveries the users of the mobile devices made that day. In some embodiments, this information can be transmitted as the deliveries occur or can be transmitted in bulk in the form of a log file periodically, such as once per day. In some embodiments, when the user of a mobile device 221-225, such as a carrier or delivery resource, delivers an item, the user can scan the item or the mailbox where the item was delivered. Scanning the item or mailbox can include an optical scan, a barcode scan, a scan of a computer readable code on the item, communicating with an RFID tag, a near field communication or Bluetooth interaction, and the like. The user is then required to state whether the item was delivered to a mailbox, door or other location at the address the user was delivering to. In some embodiments, the user must also state what kind of item was delivered, such as a letter, package, or other type of item. Alternatively the type of item that was delivered is automatically indicated by the scan. When the user scans an item or mailbox with one of the mobile devices 221-225, the mobile device records an associated GPS coordinate. The mobile device can also associate all of the information collected from its user and the GPS coordinates with a unique key for the address that the item was delivered to. All of this information for each delivery can then be received by the address analytical server 100 through communication module 120.

In some embodiments, the mobile devices 221-225 can also transmit stop information to the communication module. In some embodiments, stop information can be the time and location that a mail carrier using a mobile device 221-225 stops for a predetermined length of time. In some embodiments, the time can be 5 seconds, 1 minute, 10 minutes or any other time. In some embodiments, the mobile devices 221-225 can determine when a stop occurs through accelerometer and GPS data.

In some embodiments, when the user of one of the mobile devices 221-225 scans the item, the user can record information about how the item is delivered, called a delivery type. In some embodiments, this information can be recorded using a specific code. Table 1 lists some embodiments of the various codes for delivery type:

TABLE 1

| Code | Type of Delivery | Description |
|---|---|---|
| A | Curb-line | The delivery point is serviced |
| | | via motorized vehicle at a |
| | | mail receptacle which is |
| | | located at the curb such that |
| | | in ordinary circumstances the |
| | | carrier does not leave the |
| | | vehicle to service the box. |
| B | CBU/NDCBU | The delivery point is serviced |
| | | at a mail receptacle which is |
| | | located within a centralized |
| | | box unit, secured by a lock |
| | | and normally set on a |
| | | pedestal. |
| C | Central | A centralized delivery is a |
| | | mail receiving unit where the |
| | | carrier has access to more |
| | | than one individual |
| | | customer's receptacle by |
| | | opening only one door or box |
| | | unit. |
| D | Other (Door) | All delivery types which do |
| | | not fit into one of the above |
| | | delivery types. Type D |
| | | usually is for residential |
| | | doors (in some cases >95% |
| | | of the time). In other cases, it |
| | | can be for a business. |
| K | IDA | Internal Drop Address. |
| L | Sidewalk | Sidewalk. |
| X | Inactive | Inactive deliveries. |

In some embodiments, the user of mobile devices 221-225, such as a carrier or distribution network employee, can similarly record a code designating where the delivery took place. The code can also designate a general category associated with the exact delivery place. The following table demonstrates some embodiments of the various codes that can designate the exact delivery place:

TABLE 2

| Code | Delivery point | General Category |
|---|---|---|
| 01 | In/At Mailbox | Mailbox |
| 02 | Front Door/Porch | Door |
| 03 | Parcel Locker | N/A |
| 04 | Left w/Individual | Door |
| 05 | Front Desk/Reception | N/A |
| 06 | Garage Or Other At Address | Other |
| 07 | Neighbor | N/A |
| 08 | PO Box | N/A |
| 09 | Individual Picked Up At | N/A |
| | Postal Facility | |
| 10 | Individual Picked Up At Post | N/A |
| | Office | |
| 17 | To Mailroom | Mailbox |
| 23 | Delivered To Agent | N/A |

In some embodiments, communication module 120 can also be used to communicate with address management system 210. In some embodiments, the address management system 210 (“AMS”) contains the actual maps of delivery points. In some embodiments, the address analytical server 100 can send information to the address management system 210 to update the delivery points based on the delivery points determined by the address analytical server 100. In some embodiments, this information is stored in system memory 113 until it is transmitted to address management system 210. The following table illustrates one embodiment of the potential information that can be determined by the address analytical server 100 and sent to the address management system 210. In some embodiments, some of this information is determined by the address analytical server 100 as described further below. In some embodiments, some or all of the information can be sent. In some embodiments, only specific information, which is marked as required can be sent.

TABLE 3

| Data Type | Description | Usage | Data Type | Example |
|---|---|---|---|---|
| Zipcode | Address Zip | Optional | Integer | 20005 |
| | Code | | | |
| ZipCodePlus4 | Address Zip | Optional | Integer | 5110 |
| | Code Plus | | | |
| | Four | | | |
| ZipCodeDeliveryPoint | Zip Code | Optional | Integer | 45 |
| | Delivery | | | |
| | Point | | | |
| Address | Street | Optional | String | 1245 13TH ST |
| | Address | | | NW |
| City | City | Optional | String | WASHINGTON |
| State | State | Optional | String | DC |
| Facility ID | Facility ID | Optional | Integer | 1442221 |
| Route ID | Route ID | Optional | String | CO22 |
| SeqNum | Mobile | Optional | Integer | 23 |
| | Device | | | |
| | Carrier's | | | |
| | Address | | | |
| | Number | | | |
| AMSLatitude | Address | Optional | Number | 38.90712 |
| | Management | | | |
| | System 210 | | | |
| | Assigned | | | |
| | Geolocation | | | |
| AMSLongitude | Address | Optional | Number | −77.0298 |
| | Management | | | |
| | System 210 | | | |
| | Assigned | | | |
| | Geolocation | | | |
| AMSCoefficient | Coefficient | Optional | Integer | 37 |
| | For AMS | | | |
| | Dispersity | | | |
| | Amongst | | | |
| | Facility | | | |
| MailboxLatitude | Address | Required | Number | 38.90712 |
| | Mailbox | | | |
| | Latitude | | | |
| | Determined | | | |
| | By Address | | | |
| | Analytical | | | |
| | Server 100 | | | |
| MailboxLongitude | Address | Required | Number | −77.0298 |
| | Mailbox | | | |
| | Longitude | | | |
| | Determined | | | |
| | By Address | | | |
| | Analytical | | | |
| | Server 100 | | | |
| MailboxClusterSize | Number Of | Optional | Integer | 1, 2, 3 |
| | Output | | | |
| | Clusters | | | |
| MailboxStandardDistance | Standard | Optional | Number | 0.000914104 |
| | Distance For | | | |
| | Mailbox | | | |
| | Points | | | |
| MailboxDaysWithScans | Number Of | Optional | Integer | 1, 2, 3 |
| | Separate | | | |
| | Days With | | | |
| | Mailbox | | | |
| | Scans | | | |
| MailboxScans | Number Of | Optional | Integer | 1, 2, 3 |
| | Scans For | | | |
| | Mailbox | | | |
| MailboxSignatureScans | Number Of | Optional | Integer | 1, 2, 3 |
| | Mailbox | | | |
| | Signature | | | |
| | Scans | | | |
| MailboxScansInCluster | Number Of | Optional | Integer | 1, 2, 3 |
| | Scans For | | | |
| | Mailbox | | | |
| | Contained In | | | |
| | The Final | | | |
| | Cluster | | | |
| MailboxCarriers | Number Of | Optional | Integer | 1, 2, 3 |
| | Different | | | |
| | Mobile | | | |
| | Device | | | |
| | Users With | | | |
| | Scans At | | | |
| | The Mailbox | | | |
| MailboxCarriersInCluster | Number Of | Optional | Integer | 1, 2, 3 |
| | Different | | | |
| | Mobile | | | |
| | Device | | | |
| | Users In | | | |
| | Final Cluster | | | |
| MailboxGeofences | Number Of | Required | Integer | 1, 2, 3 |
| | Mailbox | | | |
| | Scans That | | | |
| | Prompted A | | | |
| | Geo-Fence | | | |
| | Alert | | | |
| MailboxStandardDistanceConfidence | Mailbox | Optional | Integer | 0-25 |
| | Standard | | | |
| | Distance | | | |
| | Confidence | | | |
| MailboxSizeConfidence | Mailbox | Optional | Integer | 0-25 |
| | Size | | | |
| | Confidence | | | |
| MaillboxAMSDistanceConfidence | Mailbox | Optional | Integer | 0-25 |
| | Employee | | | |
| | Confidence | | | |
| MailboxEmployeeConfidence | Mailbox | Optional | Integer | 0-25 |
| | Employee | | | |
| | Confidence | | | |
| MailboxTimeRange | Mailbox | Optional | Integer | 1, 2, 3 |
| | Time Range | | | |
| | Confidence | | | |
| MailboxTimeRange | Mailbox | Optional | Integer | 1, 2, 3 |
| | Time Range | | | |
| | Confidence | | | |
| MailboxConfidence | Mailbox | Required | Integer | 0-100 |
| | Confidence | | | |
| MailboxBuffer | Mailbox | Required | Number | 495.6554 |
| | Buffer | | | |
| MailboxToAMS | Distance | Optional | Number | 247.8277 |
| | Between | | | |
| | Mailbox | | | |
| | And AMS | | | |
| MailboxValidation | Validates | Required | String | Y, N, M, Z |
| | AMS If | | | |
| | AAS Is | | | |
| | Within 30 | | | |
| | Feet | | | |
| DoorLatitude | Address | Required | Number | 38.90701 |
| | Door | | | |
| | Latitude | | | |
| | Found By | | | |
| | AAS | | | |
| DoorLongitude | Address | Required | Number | −77.0298 |
| | Door | | | |
| | Longitude | | | |
| | Found By | | | |
| | AAS | | | |
| DoorClusterSize | Number Of | Optional | Integer | 1, 2, 3 |
| | Output | | | |
| | Clusters | | | |
| DoorStandardDistance | Standard | Optional | Number | 0.000914104 |
| | Distance For | | | |
| | Door Points | | | |
| DoorDaysWithScans | Number Of | Optional | Integer | 1, 2, 3 |
| | Separate | | | |
| | Days With | | | |
| | Door Scans | | | |
| DoorScans | Number Of | Optional | Integer | 1, 2, 3 |
| | Scans For | | | |
| | Door | | | |
| DoorSignatureScans | Number Of | Optional | Integer | 1, 2, 3 |
| | Door Scans | | | |
| | That | | | |
| | Required A | | | |
| | Signature | | | |
| DoorScansInCluster | Number Of | Optional | Integer | 1, 2, 3 |
| | Scans For | | | |
| | Door | | | |
| | Contained In | | | |
| | The Final | | | |
| | Cluster | | | |
| DoorCarriers | Number Of | Optional | Integer | 1, 2, 3 |
| | Different | | | |
| | Users Of A | | | |
| | Mobile | | | |
| | Device With | | | |
| | Scans A T A | | | |
| | Particular | | | |
| | Door | | | |
| DoorCarriersInClusters | Number Of | Optional | Integer | 1, 2, 3 |
| | Different | | | |
| | Mobile | | | |
| | Device | | | |
| | Users That | | | |
| | Recorded A | | | |
| | Scan At The | | | |
| | Door For | | | |
| | The Final | | | |
| | Cluster | | | |
| DoorGeofences | Number Of | Required | Integer | 1, 2, 3 |
| | Door Scans | | | |
| | That | | | |
| | Prompted A | | | |
| | Geo-Fence | | | |
| | Alert | | | |
| DoorStandardDistanceConfidence | Door | Optional | Integer | 0-25 |
| | Standard | | | |
| | Distance | | | |
| | Confidence | | | |
| DoorStandardDistanceConfidence | Door | Optional | Integer | 0-25 |
| | Standard | | | |
| | Distance | | | |
| | Confidence | | | |
| DoorSizeConfidence | Door Size | Optional | Integer | 0-25 |
| | Confidence | | | |
| DoorAMSDistanceConfidence | Door Ams | Optional | Integer | 0-25 |
| | Distance | | | |
| | Confidence | | | |
| DoorEmployeeConfidence | Door | Optional | Integer | 0-25 |
| | Employee | | | |
| | Confidence | | | |
| DoorTimeRange | Door Time | Optional | Integer | 1, 2, 3 |
| | Range | | | |
| | Confidence | | | |
| DoorConfidence | Door | Required | Integer | 0-100 |
| | Confidence | | | |
| DoorBuffer | Door Buffer | Required | Number | 495.6554 |
| DoorToAMS | Distance | Optional | Number | 247.8277 |
| | Between | | | |
| | Door And | | | |
| | AMS | | | |
| DoorValidation | Validates | Required | String | Y, N, M, Z |
| | AMS If | | | |
| | AAS Is | | | |
| | Within 30 | | | |
| | Feet | | | |
| SuperCluster | Signifies | Optional | String | Y, N |
| | Whether | | | |
| | Door And | | | |
| | Mailbox Are | | | |
| | Clustered As | | | |
| | One | | | |
| Rec_Type | Record Type | Optional | String | H, S |
| Delvpt_Drop_Ind | Drop | Optional | String | N |
| | Indicator | | | |
| Season_Ind | Seasonal | Optional | String | N |
| | Indicators | | | |
| Vacant_Ind | Vacant | Optional | String | N |
| | Indicator | | | |
| Dow_Non_Delv_Code | Non- | Optional | String | O |
| | Delivery | | | |
| | Days | | | |
| Firm_Name | Firm | Optional | String | Apartments |
| | Records | | | |
| Nostat_Code | Cds No-Stat | Optional | String | N, Y |
| Usage Code | Usage | Optional | String | A, B |
| | Codes | | | |
| Delvtype_Code | Code That | Optional | String | A, B, C, D, X, L |
| | Indicates | | | |
| | What Type | | | |
| | Of Delivery | | | |
| | Destination | | | |
| | It Is | | | |
| DelSysID | Delivery | Required | String | 2001-08-20- |
| | System ID: | | | 11.00.04.973755 |
| | A Unique | | | |
| | Identifier | | | |
| | For An | | | |
| | Address | | | |

In some embodiments, communication module 120 can also be used to communicate with other databases (not shown). In some embodiments, communication module can receive all of the information discussed above with regards to the mobile devices 221-225 from a database instead of from a mobile device. In some embodiments, one of the other databases can be a parcel database. In some embodiments, the parcel database can contain a geolocation for the center of the street facing side of each land parcel that a mail carrier could deliver to.

In some embodiments, address analytical server system hub 110 is in communication with cluster identification module 130. In some embodiments, the cluster identification module 130 may comprise a processor, memory, databases, address and control lines, and other components similar to those described herein for the system hub 110. In other embodiments, cluster identification module 130 may be configured to use the processor, memory, databases, address and control lines, and other components of the address analytical server system hub 110, or a combination of its own components and the address analytical server system hub 110's components.

In some embodiments, cluster identification module 130 is used to determine clusters of geolocations of the scans recorded by the mobile devices 221-225 for individual addresses. These clusters than can be used to develop new delivery points for individual addresses. In some embodiments, the cluster identification module can identify a cluster by collecting all of the geolocations for all scans associated with an individual address. In some embodiments, the cluster identification module 130 then determines clusters with a clustering methodology based on those scans. The cluster identification module 130 can then determine a single location based on the cluster and clustering methodology. In some embodiments, the cluster identification module can use the DBSCAN clustering methodology, K-Means Cascading clustering methodology, and K-Means X-Means clustering methodology. In some embodiments, the DBSCAN clustering methodology can be advantageously used because the DBSCAN methodology can more correctly identify a single eventual value from a scan cluster.

In some embodiments, cluster identification module 130 can identify multiple clusters for a single address. For example, cluster identification module 130 can determine separate clusters for the mailbox, door, and driveway. In some embodiments, the cluster identification module can also determine a single cluster for multiple addresses. For example, the cluster identification module 130 can determine a single mailbox cluster for delivery to multiple addresses. In some embodiments, what type of clustering the clustering module does can be determined by the delivery type and their ZIP+4 code, as used by the United States Postal Service. For example, for all addresses with the same ZIP+4 code with a delivery code “B” designating that mail is delivered to a centralized box unit mailbox, the cluster identification module 130 can cluster all mailbox scans for all the address together, while clustering all the doors scans for all address separately. Similarly, for all addresses with the same ZIP+4 code with a delivery code “C” designating a centralized mail receiving unit where delivery resource has access to more than on individual customer's receptacle by opening only one door or box unit, the cluster identification module 130 can cluster all mailbox scans for all the address together, while clustering all the doors scans for all address together. Similarly, for all single addresses with the delivery code D, designating a business or other alternative delivery, the clustering algorithm can cluster all mailbox and door scans together. Finally, for all single address with any other delivery code, the clustering algorithm can cluster all mailbox and door scans separately.

In some embodiments, the cluster identification module can automatically exclude some scans from being clustered. In some embodiments, scans delivered to type D address that designated as package scans will be excludes from the process if they are scanned within 45 seconds of a previous scan. In some embodiments, scans that are greater than a certain distance away from the previously calculated AMS coordinate will be excluded. In some embodiments, this distance can be 100 feet, 1 mile, 5 miles, or another distance.

In some embodiments, address analytical server system hub 110 is in communication with cluster confidence module 140. In some embodiments, cluster confidence module 140 may comprise a processor, memory, databases, address and control lines, and other components similar to those described herein for the system hub 110. In other embodiments, cluster confidence module 140 may be configured to use the processor, memory, databases, address and control lines, and other components of the address analytical server system hub 110, or a combination of its own components and the address analytical server system hub 110's components.

In some embodiments, cluster confidence module 140 determines a confidence value for each cluster identified by the cluster identification module 130. In some embodiments, cluster confidence module 140 can determine a confidence value based on numerous criteria. In some embodiments, the cluster confidence module 140 can determine the full confidence value based on individual confidence values based on confidence criteria.

For example, the number of scans in the cluster can affect the confidence value (“Size Confidence”). In some embodiments, the individual Size Confidence value can increase in a range from 0-30. In some embodiments, the individual value can increase linearly with the number of scans before tapering off as the individual value approaches 30.

In some embodiments, the proximity in detected scan locations or transmitted scan locations for multiple scans at the same delivery point can also affect confidence (“Standard Distance Confidence”). In some embodiments, the proximity of multiple scans can be measured using the statistical measure of standard distance. As the standard distance of the scans decreases, the confidence value increases. This individual confidence value can range from 0-30.

In some embodiments, the confidence value can be affected based on the distance between the single values calculated from the clusters from the cluster identification module 130 and the current location of a delivery point stored in the address management system 210 (“AMS Distance Confidence”). In some embodiments, the confidence value of the cluster location is lowered if the single value calculated from a cluster for a delivery point is not within a certain radius of the current location of a delivery point stored in address management system 210, the individual confidence value can be decreased. In some embodiments, the radius can by dynamically related to the density of the addresses in the area the delivery point is in. In some embodiments, this individual confidence value can be between 0-50. In some embodiments, if the single value calculated from the cluster and the previous location stored in the AMS is exactly the same, this confidence value can be set to 50.

In some embodiments, the overall confidence value can be affected based on the number and/or identity of different users of the mobile devices 221-225 that created a scan in the cluster (“Employee Confidence”). In some embodiments, as the number of different users increases the individual Employee Confidence value increases. In some embodiments, this value can range from 0-30.

In some embodiments, the overall confidence value can be affected based on the number of different days from which at least one scan in a cluster was created (“Time Confidence”). Multiple scans in a single day have less value from a confidence standpoint as compared to multiple scans over multiple days. As the number of days increases, the confidence value can also increase. In some embodiments, an individual Time Confidence can range from 0-10.

In some embodiments, cluster confidence module 140 can determine the overall confidence value by adding together all of the individual confidence values described above. In some embodiments, the confidence values can instead be scaled so that that the maximum overall confidence value is 100.

In some embodiments, the overall confidence value can instead be calculated by adding only the individual confidence values for Standard Distance Confidence, Size Confidence, Employee Confidence, and Time Confidence, for a maximum confidence value of 100.

In some embodiments, if the calculated coordinates of a new location for the delivery point are the same as a previous location stored in the Address Management System 210, the new location coordinates can be assigned a default confidence of 70. The overall confidence value can then be calculated by adding the scaled version Standard Distance Confidence, Size Confidence, Employee Confidence, and Time Confidence to the default confidence. In some embodiments, Standard Distance Confidence is scaled to 0-9, Size Confidence is scaled to 0-9, Employee Confidence is scaled to 0-9, and Time Confidence is scaled to 0-3, for a possible maximum of 100.

In some embodiments, address analytical server system hub 110 is in communication with cluster selection module 150. In some embodiments, the cluster selection module 150 may comprise a processor, memory, databases, address and control lines, and other components similar to those described herein for the system hub 110. In other embodiments, cluster selection module 150 may be configured to use the processor, memory, databases, address and control lines, and other components of the address analytical server system hub 110, or a combination of its own components and the address analytical server system hub 110's components.

In some embodiments, cluster selection module 150 can determine which new delivery points calculated from the clusters identified by the cluster identification module 130 to update the address management system with. In some embodiments, the cluster selection module 150 can determine which locations to update based on the geo-coordinates of the new location and the overall confidence value associated with that new location. In some embodiments, cluster selection module 150 can also compare the distance new delivery point associated with an address is from the old delivery point for that address in order to determine whether to update.

In some embodiments, the cluster selection module 150 can choose to update with any new delivery point that has an overall confidence value greater than a predetermined threshold. In some embodiments, the AAS 100 will continue to update the geo-coordinates of delivery points until the confidence value is 100, or is within a few points of 100. In some embodiments, AAS 100 will determine that the geo-coordinates need no longer be updated when new scan data is received if the confidence value is at or exceeds a predetermined threshold. In some embodiments, that threshold can be 70, 80, 90, or any other desired value.

In some embodiments, the cluster selection module 150 can also select new locations to update for example, based on table 4 below.

TABLE 4

| Description | Update? |
|---|---|
| The new location is equal to the old location | No |
| The new locations is greater than 30 feet | No |
| from the old location | |
| The new location is less than 30 feet from the | Yes |
| old location and the overall confidence value | |
| is less than the threshold | |
| The new location is less than 30 feet from the | No |
| old location | |
| The new location's coordinates are the same | Yes |
| as the old location's coordinates | |

In some embodiments, instead of or in addition to updating the Address Management System 210 system with the new delivery point information, the cluster selection module 150 can save the newly calculated delivery point. In some embodiments, this saved point can be called the AAS1 point. In some embodiments, the newly calculated delivery point is saved as the AAS1 point only the confidence value for the newly calculated delivery point is high enough, for example over 70.

In some embodiments, address analytical server system hub 110 is in communication with stop analysis module 160. In some embodiments, stop analysis module 150 can be used to determine more accurate delivery points for various locations based on stop information. In some embodiments, the stop analysis module 160 can start determining more accurate delivery point information by calculating an anchor point for each delivery within a route. In some embodiments, a route can be an ordered set of delivery points that a mail carrier could deliver mail to. In some embodiments, an anchor point can be one of either the delivery point for a location on a route in the Address Management System, the delivery point stored in the parcel database or the AAS1 point. In some embodiments, the stop analysis module 160 selects one of these three points as the anchor point. In some embodiments, the stop analysis module 160 selects the AAS1 point as the anchor point if the delivery point is for a cluster box unit. If the delivery point is not for a cluster box unit, the stop analysis module 160 selects the delivery point stored in the parcel database, if available. If that is unavailable, the stop analysis module selects the AAS 1 point, if available. If neither the AAS1 point or the point in the parcel database are available, the stop analysis unit selects the location stored in Address Management System 210. In some embodiments, the priority of delivery points selected can be in any order of the three listed above.

Once the anchor point has been selected, in some embodiments, the stop analysis module can then analyze stop data it has received and associate the stops with each delivery point. In some embodiments, the anchor for each delivery point in a route is used to get a list of stop geolocations associated with that point. The stop geolocations are selected based on proximity to the anchor point and the bearing between the last detected stop and the current stop. The stops that exceed the distance or bearing tolerances are invalidated. For example, all stops that are located within 10 meters or 20 meters of the delivery point and that have a bearing coming from the immediately preceding delivery point and heading to the next delivery point on the route can be used.

In some embodiments, the stop analysis module 160 then looks at each delivery point within a route that is not a cluster box that does not have any stop information associated with it. This type of delivery point missing stop information is referred to as a gap. If a gap has a high confidence AAS1 record associated with it or the neighboring delivery points do not have any associated stops that gap is ignored. For the remaining gaps, the stops that have not been associated with a delivery point are checked and if a stop is found that falls within the time window between the neighboring delivery point stop times, that stop is associated to the gap. Additionally, the stops associated with the neighboring delivery points are checked and if the gap's anchor point is a better match than the neighbor's anchor point that stop is associated with the gap.

In some embodiments, once all the stops have been associated with delivery points into a stop cluster, the stop analysis module 10 then determines a single location based on the cluster. In some embodiments, stop analysis module 10 can use the DBSCAN clustering methodology, K-Means Cascading clustering methodology, and K-Means X-Means clustering methodology. In some embodiments, the DBSCAN clustering methodology can be advantageously used because the DBSCAN methodology can more correctly identify a single eventual value from a stop cluster.

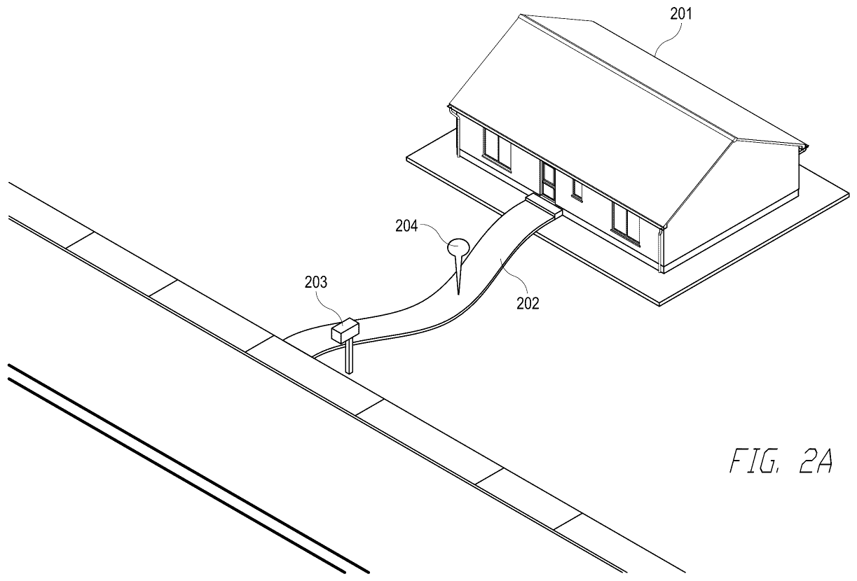

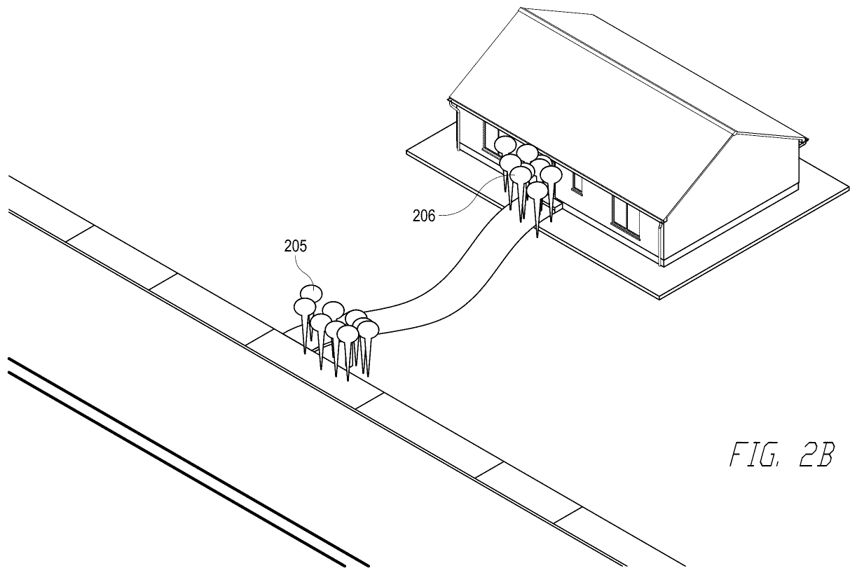

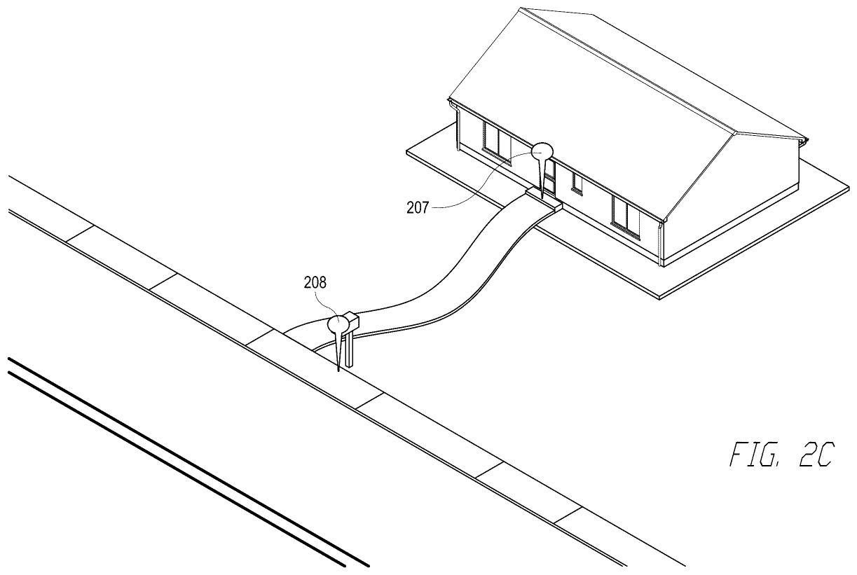

FIGS. 2a-2c are diagrams illustrating exemplary processes of the address analytical server 100 for generating new geo-coordinates for a delivery point. FIG. 2a displays an address with a house 201, a drive way 202, mailbox 203 and delivery point 204. As seen in FIG. 2a, the delivery point 204 is marked in the center of the driveway. FIG. 2b then displays two clusters of delivery scans or stop points, 205 and 206. These cluster represents scans of the deliveries or clusters of stop points as described elsewhere. FIG. 2c shows a mailbox delivery point 208 and a door delivery point 207. In some embodiments, these new delivery points were calculated from the clusters 205 and 206 as described elsewhere.

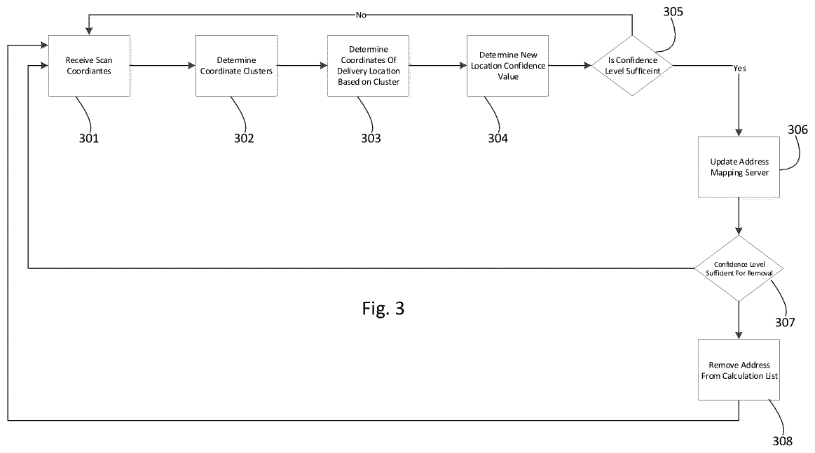

FIG. 3 is a flow chart depicting one embodiment of a process for using the address analytical server 100 to generate new geo-coordinates for a delivery point. In some embodiments, the process starts with process block 301. In process block 301, address analytical server system 110 receives the scan coordinates of the scans of various items that have been delivered to a delivery point, for delivery points along a specified route, or for any other set of delivery points. In some embodiments, analytical server system 100 receives these scans and the associated information from mobile devices 221-225 as described elsewhere. The process then proceeds to process block 302.

In process block 302, the address analytical server system 100 determines coordinate clusters from the scan coordinates that it received. In some embodiments, cluster identification module 130 arranges the received scans into clusters in the manner described elsewhere. The process then proceeds to process block 303.

In process block 303, the address analytical server system 100 calculates a single delivery point for each cluster. In some embodiments, the cluster identification module 130 calculates this single location in the manner described elsewhere. The process then proceeds to process block 304.

In process block 404, the address analytical server system 100 determines a confidence value for each new delivery point calculated from the various clusters. In some embodiments, the cluster confidence module 140 calculates a confidence value for each new delivery point in the manner described elsewhere. The process then proceeds to decision block 305.

In decision block 305, the address analytical server system 100 determines if the confidence level associated with each new location is sufficient to update the address management system 210. In some embodiments, the cluster selection module 150 performs this selection based on the criteria described elsewhere. If the confidence value is not sufficient for any new location, the process then returns to process block 301 to await additional scans. If the confidence value for at least one location is sufficient, the process then proceeds to process block 306.

In process block 306, address analytical server system 100 updates the delivery points in address management system 210 for each new location with a sufficiently high confidence value. In some embodiments, the address analytical server system 100 sends the updates via communication module 120. The process then proceeds to decision block 307.

In decision block 307, the address analytical server system 100 determines if the confidence values associated with the new locations for each address sent to the address management system 210 have a sufficient confidence value to be removed from the list of addresses that need to be processed. In some embodiments, if the confidence value associated with a new location is the maximum value, the address analytical server system will no longer calculate new locations for this address even when the system receives new scans for that address in process block 301. If there are no locations with a sufficient confidence level, the process returns to process block 301. If there are locations with a sufficient confidence level, the process proceeds to process block 308.

In process block 308, the address analytical server system 100 removes addresses with delivery points with a sufficient confidence value from the list of address that need locations. In future iterations of process 300, these locations no longer have clusters identified and new delivery points calculated from these clusters. The process then returns to process block 301.

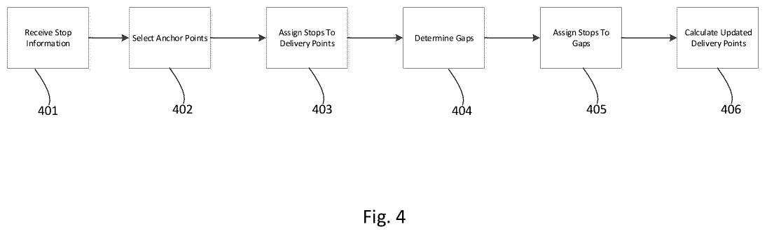

FIG. 4 is another flow chart depicting one embodiment of a process for using the address analytical server 100 to generate new geo-coordinates for a delivery point. The process starts in process block 401. In process block 401, the address analytical server 100 receives stop data either from a stop data database or directly from mobile devices 221-225. The process the proceeds to process block 402.

In process block 402, the address analytical server 100 uses the stop analysis module 160 to select anchor points for every delivery point in a delivery route. In some embodiments, the stop analysis module 160 selects the anchor point in the manner previously described. The process than proceeds to process block 403.

In process block 403, the address analytical server 100 uses the stop analysis module 160 assigns individual stops from the stop information to various delivery points. In some embodiments, the stop analysis module assigns the individual stops to each delivery point based on the proximity of the stop to the anchor point for that delivery point and the bearing for each stop in the manner previously described. The process then proceeds to process block 404.

In process block 404, the stop analysis module identify any delivery point that has no stops associated with it in the manner previously described. The process then proceeds to process block 405.

In process block 405, the stop analysis module 160 considers and assigns stops to each gap in the manner previously described. For example, if a gap has a high confidence AAS1 record associated with it or the neighboring delivery points do not have any associated stops that gap is ignored. For the remaining gaps, the stops that have not been associated with a delivery point are checked and if a stop is found that falls within the time window between the neighboring delivery point stop times, that stop is associated to the gap. Additionally, the stops associated with the neighboring delivery points are checked and if the gap's anchor point is a better match than the neighbor's anchor point that stop is associated with the gap. The process the proceeds to process block 405.

In process block 405, the sop analysis module 160 determines a single geolocation for each delivery point based on a clustering methodology for each cluster of stops in the manner previously described.

Various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and steps described above. Whether such functionality is implemented in hardware or software depends upon the particular application and design constraints imposed on the overall system.

In one or more aspects, the functions described herein may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, e.g., one or more modules of computer program instructions, encoded on a computer storage media for execution by, or to control the operation of, data processing apparatus.

If implemented in software, the functions may be stored on or transmitted over as one or more instructions or code on a computer-readable storage medium. The steps of a method or algorithm disclosed herein may be implemented in a processor-executable software module which may reside on a computer-readable storage medium. Computer-readable storage media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above can also be included within the scope of computer-readable storage media. Additionally, the operations of a method or algorithm may reside as one or any combination or set of codes and instructions on a machine readable storage medium and computer-readable storage medium, which may be incorporated into a computer program product.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Instructions refer to computer-implemented steps for processing information in the system. Instructions can be implemented in software, firmware or hardware and include any type of programmed step undertaken by components of the system.

As can be appreciated by one of ordinary skill in the art, each of the modules of the invention may comprise various sub-routines, procedures, definitional statements, and macros. Each of the modules are typically separately compiled and linked into a single executable program. Therefore, the description of each of the modules is used for convenience to describe the functionality of the system. Thus, the processes that are undergone by each of the modules may be arbitrarily redistributed to one of the other modules, combined together in a single module, or made available in a shareable dynamic link library. Further each of the modules could be implemented in hardware. A person of skill in the art will understand that the functions and operations of the electrical, electronic, and computer components described herein can be carried out automatically according to interactions between components without the need for user interaction.

The foregoing description details certain embodiments. It will be appreciated, however, that no matter how detailed the foregoing appears in text, the development may be practiced in many ways. It should be noted that the use of particular terminology when describing certain features or aspects of the development should not be taken to imply that the terminology is being re-defined herein to be restricted to including any specific characteristics of the features or aspects of the development with which that terminology is associated.

While the above detailed description has shown, described, and pointed out novel features of the development as applied to various embodiments, it will be understood that various omissions, substitutions, and changes in the form and details of the device or process illustrated may be made by those skilled in the technology without departing from the intent of the development. The scope of the development is indicated by the appended claims rather than by the foregoing description. All changes which come within the meaning and range of equivalency of the claims are to be embraced within their scope.

What is claimed is:

1. A method for improving geolocations of delivery points, the method comprising:
storing an initial geolocation for each of the plurality of delivery addresses of a delivery route; and
receiving, in one or more processors, stop data generated as a plurality of delivery resources traverse a plurality of delivery routes, the stop data comprising stop geolocations and stop times;
associating, by the one or more processors, one or more of the stop geolocations of the stop data with one or more of the initial geolocations of the plurality of delivery addresses;
identifying, by the one or more processors, delivery addresses of the plurality of delivery addresses with which no stop data is associated;
determining, by the one or more processors, delivery addresses with which no stop data is associated as gaps;
identifying, by the one or more processors, stop geolocations in the stop data that have not been associated with any of the plurality of delivery addresses;
determining, by the one or more processors, whether the stop time for stop geolocations that have not been associated with any of the plurality of delivery addresses fall at a time between stop times associated with stop geolocations associated with delivery addresses located before and after the gap along the delivery route;
assigning, by the one or more processors, the stop geolocations that fall at a time between stop times associated with stop geolocations associated with delivery addresses located before and after the gap along the delivery route to the gap; and
determining, by the one or more processors, a final geolocation for each of the plurality of delivery addresses based on the associated stop geolocations.

2. The method of claim 1, further comprising:
generating, by the one or more processors, a confidence score for the final geolocation;
comparing, by the one or more processors, the confidence score for the final geolocation with a confidence score of the initial geolocation; and
if the confidence score for the final geolocation is higher than the confidence score of the initial geolocation, updating, by the one or more processors, the delivery route.

3. The method of claim 1, further comprising associating one or more of the stop geolocations with one or more of the initial geolocations of the plurality of delivery addresses based on proximity of the stop geolocations with the one or more initial geolocations.

4. The method of claim 1, further comprising associating, by the one or more processors, one or more of the stop geolocations with one or more of the initial geolocations of the plurality of delivery addresses based a bearing in the stop data indicating a direction of travel from a previous delivery address along the delivery route.

5. The method of claim 1, further comprising determining, by the one or more processors, a likely delivery address associated with the gap based on the stop data including geolocations indicating a prior delivery address and a subsequent delivery address for the gap.

6. The method of claim 5, further comprising determining, by the one or more processors, a confidence value of the initial geolocation of the likely delivery address associated with the gap, and, where the confidence value of the initial geolocation of the likely delivery address is at or above a threshold value, determining that no stop geolocations need to be associated with the gap.

7. The method of claim 5, further comprising determining, by the one or more processors, that no stop geolocation need to be associated with the gap where stop geolocations exist in the stop data for the prior delivery address and the subsequent delivery address.

8. The method of claim 1, further comprising:
comparing, by the one or more processors, stop geolocations associated with delivery addresses neighboring the gap;
determining, by the one or more processors, whether the stop geolocations associated with delivery addresses neighboring the gap are closer to the initial geolocation of the gap than to the initial geolocation for the delivery addresses with which they are associated; and
assigning, by the one or more processors, stop geolocations that are closer to the initial geolocation of the gap to the gap.

9. The method of claim 1, wherein each delivery address comprises a plurality of delivery location types, wherein the memory stores an initial location for each of the plurality of delivery location types of each delivery address, and wherein the stop data further comprises delivery location types.

10. The method of claim 9, wherein the one or more processors are configured to associate one or more of the stop geolocations of the stop data only with one or more of the initial geolocations having the delivery location type specified in the stop data for each of the stop geolocations.

11. A system for improving geolocations of delivery points, the system comprising:
a memory storing an initial geolocation for each of the plurality of delivery addresses in a delivery route; and
one or more processors configured to:
receive stop data generated as a plurality of delivery resources traverse a plurality of delivery routes, the stop data comprising stop geolocations and stop times;
associate one or more of the stop geolocations of the stop data with one or more of the initial geolocations of the plurality of delivery addresses;
identify delivery addresses of the plurality of delivery addresses with which no stop data is associated;
determine delivery addresses with which no stop data is associated as gaps;
identify stop geolocations in the stop data that have not been associated with any of the plurality of delivery addresses;
determine whether the stop time for stop geolocations that have not been associated with any of the plurality of delivery addresses fall at a time between stop times associated with stop geolocations associated with delivery addresses located before and after the gap along the delivery route;
assign the stop geolocations that fall at a time between stop times associated with stop geolocations associated with delivery addresses located before and after the gap along the delivery route to the gap; and
determine a final geolocation for each of the plurality of delivery addresses based on the associated stop geolocations.

12. The system of claim 11, wherein the one or more processors are further configured to:
generate a confidence score for the final geolocation;
compare the confidence score for the final geolocation with a confidence score of the initial geolocation; and
if the confidence score for the final geolocation is higher than the confidence score of the initial geolocation, update the delivery route.

13. The system of claim 11, wherein the one or more processors are further configured to associate one or more of the stop geolocations with one or more of the initial geolocations of the plurality of delivery addresses based on proximity of the stop geolocations with the one or more initial geolocations.

14. The system of claim 1, wherein the one or more processors are further configured to associate one or more of the stop geolocations with one or more of the initial geolocations of the plurality of delivery addresses based a bearing in the stop data indicating a direction of travel from a previous delivery address along the delivery route.

15. The system of claim 1, wherein the one or more processors are further configured to determine a likely delivery address associated with the gap based on the stop data including geolocations indicating a prior delivery address and a subsequent delivery address for the gap.

16. The system of claim 15, wherein the one or more processors are further configured to determine a confidence value of the initial geolocation of the likely delivery address associated with the gap, and, where the confidence value of the initial geolocation of the likely delivery address is at or above a threshold value, determining that no stop geolocations need to be associated with the gap.

17. The system of claim 15, wherein the one or more processors are configured to determine that no stop geolocation need to be associated with the gap where stop geolocations exist in the stop data for the prior delivery address and the subsequent delivery address.

18. The system of claim 11, wherein the one or more processors are configured to:
compare stop geolocations associated with delivery addresses neighboring the gap;
determine whether the stop geolocations associated with delivery addresses neighboring the gap are closer to the initial geolocation of the gap than to the initial geolocation for the delivery addresses with which they are associated; and
assign stop geolocations that are closer to the initial geolocation of the gap to the gap.

19. The system of claim 11, wherein each delivery address comprises a plurality of delivery location types, wherein the memory stores an initial location for each of the plurality of delivery location types of each delivery address, and wherein the stop data further comprises delivery location types.

20. The system of claim 19, wherein the one or more processors are configured to associate one or more of the stop geolocations of the stop data only with one or more of the initial geolocations having the delivery location type specified in the stop data for each of the stop geolocations.
